(19) United States
(12) Patent Application Publication
(10) Pub. No.: US 2006/0002274 A1
(43) Pub. Date: Jan. 5, 2006

(54) Hologram duplication method

(75) Inventors: Nobuhiro Kihara, Kanagawa (JP); Tomoki Kanesaka, Miyagi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SONY CORPORATION, Tokyo (JP)

(21) Appl. No.: 11/167,313

(22) Filed: Jun. 28, 2005

(30) Foreign Application Priority Data
Jun. 30, 2004 (JP) 2004-192570

(51) Int. Cl. G11B 7/00

(52) U.S. Cl. 369/103; 369/112.01

(57) ABSTRACT

A hologram duplication method is disclosed which makes it easy to duplicate a large number of holograms from a volume-recorded hologram, particularly from a hologram recorded in a recording medium of the disk type or the card type. N card type master recording media are prepared, and data pages are individually recorded on the N disk type master recording media without being multiplexed by changing the angle of a reference light beam among the N disk type master recording media. Thereafter, the data page recorded on each of the disk type master recording media is recorded on a common disk type duplication recording medium so that the data pages are N-multiplex recorded finally on the disk type duplication recording medium.

### BACKGROUND OF THE INVENTION

This invention relates to a hologram duplication method for duplicating a hologram recording medium in which data pages are multiplex recorded in accordance with an angle multiplexing method.

In recent years, a holographic technique has been developed rapidly in order to place a holographic memory into practical use, which attracts attention as a very promising candidate for a storage which is competitive with optical disks of the next generation and the next next generation. A hologram recording and reproduction system which makes use of a hologram technique to record and reproduce a large amount of data has been proposed and is disclosed, for example, in “Holographic data storage”, IBM J. RES DEVELOP, Vol. 44, No. 3, May 2000.

Such a hologram recording and reproduction system as described above uses a method called multiplex recording in order to achieve high density recording. The multiplexing recording records a large number of independent data pages in the same area of a hologram recording medium. As representative ones of such multiplexing recording methods, angle multiplex recording, shift multiplex recording and phase code multiplex recording are known.

The angle multiplex method successively changes the angle of a reference light beam to record and reproduce a large number of independent pages at one place. The shift multiplex method successively shifts the recording position little by little to achieve multiplex recording. The phase multiplex method irradiates reference beams having various phases in various directions at a time to record one page, and a large number of pages are recorded or reproduced using various combinations of the various phases. Also many other multiplex methods are available in addition to the three multiplex methods described above. For example, a multiplex method called speckle multiplex (or correlation multiplex) method is known.

Incidentally, in order to commercialize a hologram recording medium on which video data and so forth are multiplex recorded in the form of holograms, it is necessary to duplicate a large number of hologram recording media on which the same video data are recorded from a master hologram recording medium on which such video data are multiplex recorded. Accordingly, in order to popularize the holographic storage, it is significant to develop a duplication technique of holograms.

Conventionally, duplication of holograms is carried out on a large scale principally in the field of display holograms, and various methods are known. For example, a method which makes use of emboss holograms and another method which makes use of contact copying have been placed into practical use. Although, from the point of view of the holographic storage, the number of established methods for duplication is not great, a method of using a conical beam to duplicate a hologram from a disk type master recording medium on which data are recorded bit by bit is disclosed in U.S. Published Application No. 2003/0161246.

### SUMMARY OF THE INVENTION

However, a conventional emboss type duplication method of the surface roughness transfer type cannot duplicate a volume-recorded data page (hologram). Further, in contact copying of a conventional type, since a parallel light beam is used, it is difficult to produce a reference beam for use upon duplication which has a same wavefront as that of a reference beam used upon production of a master disk. Particularly it is difficult to reproducibly duplicate holograms recorded in a disk type recording medium. Further, a master disk recorded data bit by bit from a volume-recorded hologram using a conical beam by a method disclosed in U.S. Published Application No. 2003/0161246 cannot be produced. Therefore, it is still impossible to reproducibly duplicate volume-recorded holograms.

It is an object of the present invention to provide a hologram duplication method which makes it easy to duplicate a large number of holograms from a volume-recorded hologram, particularly from a hologram recorded in a recording medium of the disk type or the card type.

In order to attain the object described above, according to the present invention, a conical light beam or an obliquely incoming light beam is irradiated upon a disk type or a card type master recording medium such that interference fringes between signal beam produced by diffraction of the conical light beam or the obliquely incoming light beam by the disk type or card type master recording medium and the conical light beam or obliquely incoming light beam passing through the disk type or card type master recording medium are recorded collectively on the disk type or card type duplication recording medium.

In particular, according to an embodiment of the present invention, there is provided a hologram duplication method for duplicating data pages recorded in a holographic form on a disk type master recording medium on a disk type duplication recording medium disposed in the proximity of the disk type master recording medium, including the steps of irradiating a conical light beam upon the disk type master recording medium, and recording interference fringes collectively on the disk type duplication recording medium, the interference fringes are formed with signal beam produced by diffraction of the conical light beam by the disk type master recording medium and the conical light beam passing through the disk type master recording medium are recorded.

Preferably, N disk type master recording media are prepared, N being a natural number, and the data pages are individually recorded on the N disk type master recording media without being multiplexed by changing the angle of a reference light beam among the N disk type master recording media, whereafter the data page recorded on each of the disk type master recording media is recorded on the common disk type duplication recording medium so that the data pages are N-multiplex recorded finally on the disk type duplication recording medium.

According to another embodiment of the present invention, there is provided a hologram duplication method for duplicating data pages recorded in a holographic form on a card type master recording medium on a card type duplication recording medium disposed in the proximity of the card type master recording medium, including the steps of irradiating a obliquely incoming light beam upon the card type master recording medium, and recording interference fringes collectively on the disk type duplication recording medium, the interference fringes are formed with signal beam produced by diffraction of the obliquely incoming light beam by the card type master recording medium and the obliquely incoming light beam passing through the card type master recording medium are recorded collectively on the card type duplication recording medium.

Preferably, N card type master recording media are prepared, N being a natural number, and the data pages are individually recorded on the N card type master recording media without being multiplexed by changing the angle of a reference light beam among the N card type master recording media, whereafter the data page recorded on each of the card type master recording media is recorded on the common card type duplication recording medium so that the data pages are N-multiplex recorded finally on the card type duplication recording medium.

In the hologram duplication methods, for example, when a data page (master hologram) recorded in a holographic form on a disk type master recording medium is duplicated on a disk type duplication recording medium disposed in the proximity of the disk type mater recording medium, for example, N card type master recording media are prepared. Then, the data pages are individually recorded on the N disk type master recording media without being multiplexed by changing the angle of a reference light beam among the N disk type master recording media. Thereafter, the data page recorded on each of the disk type master recording media is recorded on the common disk type duplication recording medium so that the data pages are N-multiplex recorded finally on the disk type duplication recording medium. Thus, a large number of duplicates of a volume-recorded hologram, particularly of a hologram recorded on a disk type recording medium or a card type recording medium, can be produced readily.

With the hologram duplication methods, a conical light beam or an obliquely incoming light beam is irradiated upon the disk type or card type master recording medium such that interference fringes between signal beam produced by diffraction of the conical light beam or obliquely inputting light beam by the disk type or card type master recording medium and the conical light beam or obliquely inputting light beam passing through the disk type or card type master recording medium are recorded collectively on the disk type or card type duplication recording medium. Consequently, a large number of duplicates of a volume-recorded hologram, particularly of a hologram recorded on a disk type recording medium or a card type recording medium, can be produced readily.

The above and other objects, features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a flow chart illustrating a general procedure of a hologram duplication method to which the present invention is applied;

FIGS. 2A to 2E are schematic views illustrating a particular procedure of the hologram duplication method illustrated in FIG. 1;

FIG. 3 is a schematic view showing an incoming direction of a reference beam;

FIGS. 4A and 4B are schematic views illustrating an intensity ratio between signal beam reproduced upon duplication of a hologram disk and reference light not diffracted;

FIGS. 5 and 6 are schematic sectional views illustrating different methods of duplicating a master hologram using a cone mirror as an optical part for production of a conical beam;

FIGS. 7A and 7B are schematic views illustrating a difference between a parallel light flux and a conical light flux;

FIG. 8 is a flow chart illustrating a general procedure of another hologram duplication method to which the present invention is applied; and

FIGS. 9A to 9E are schematic views illustrating a particular procedure of the hologram duplication method illustrated in FIG. 8.

### DETAILED DESCRIPTION OF THE PREFERRED EMBODIMENTS

### First Embodiment

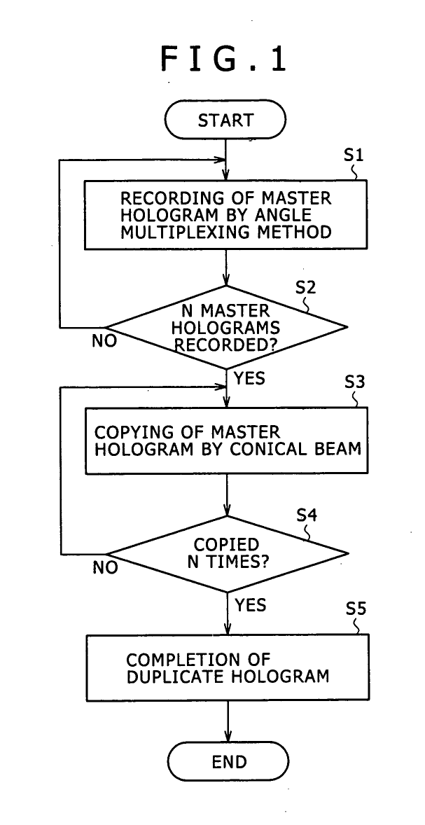

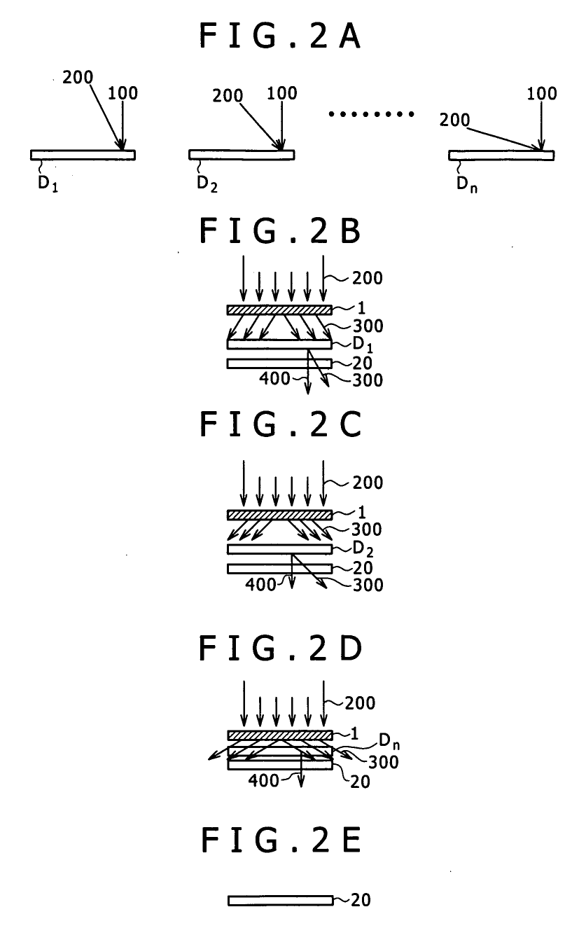

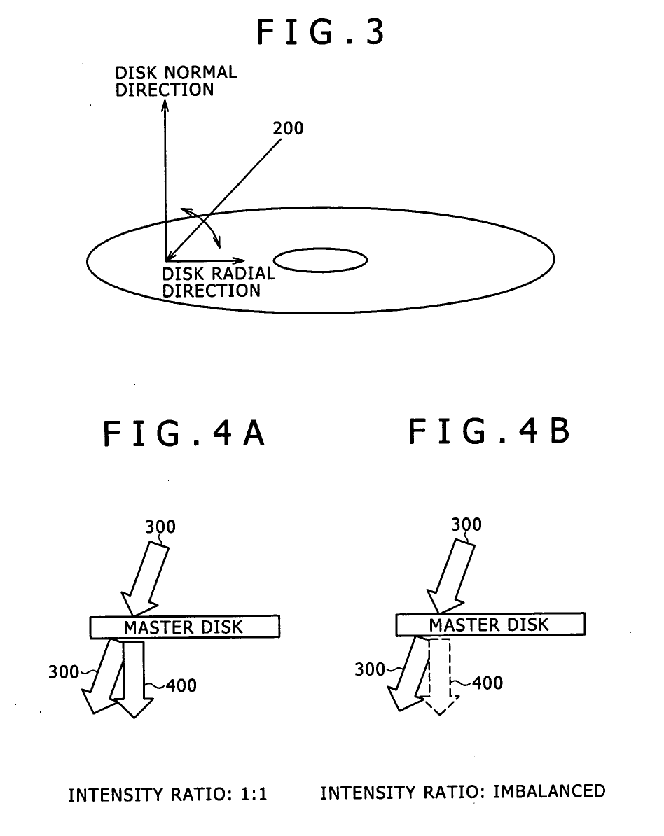

Referring first to FIG. 1, there is illustrated a general procedure of a hologram duplication method to which the present invention is applied. First, N master disks on which master holograms (data pages) are recorded in accordance with the angle multiplex method are produced (steps S1 and S2). In particular, as seen in FIG. 2A, data pages to be N-multiplexed originally are recorded, on a disk-type hologram material for each one data page, as interference fringes between a reference light beam 200 whose incoming angle varies and a signal light beam 100 spatially optically modulated by the data page. Consequently, N master disks D₁ to Dₙ are produced. It is to be noted, however, that the incoming angle of the reference light beam 200 is varied within a plane defined by a disk normal line and a disk radial direction as seen in FIG. 3.

Then, copying of the master holograms recorded on the n master disks D₁ to Dₙ to a single duplication hologram material 20 is performed (steps S3 and S4). More particularly, the reference light beam 200 in the form of parallel beam is converted into a conical light beam 300 by means of a conical beam producing optical part 1 as seen in FIG. 2B, and the conical light beam 300 is irradiated upon the master disk D₁. In this instance, the incoming angle of the conical light beam 300 to the master disk D₁ is set equal to the incoming angle of the reference light beam 200 used for production of the master disk D₁. Consequently, signal beam 400 is reproduced in accordance with the hologram recorded on the master disk D₁, and the signal beam 400 and the conical light beam 300, which has passed through the master disk D₁ without being diffracted by the master disk D₁, interfere with each other on the duplication hologram material 20. Thereupon, interference fringes of the signal beam 400 and the conical light beam 300 are recorded on the duplication hologram material 20. The master hologram recorded on the master disk D₁ is copied collectively to the duplication hologram material 20.

Then, the master hologram recorded in the master disk D₂ is copied to the same duplication hologram material 20 by a similar method as seen in FIG. 2C. In this instance, however, the incoming angle of the conical light beam 300 to the master disk D₂ is set equal to the incoming angle of the reference light beam 200 used for production of the master disk D₂. Therefore, the conical beam producing optical part 1 to be used in this instance is exchanged for another conical beam producing optical part by which the conical light beam 300 of the incoming angle is to be generated. At this point of time, data pages are recorded in a two-multiplexed form on the duplication hologram material 20. Thereafter, a similar process is repeated until a data page recorded on the master disk Dₙ is copied to the same duplication hologram material 20 as seen in FIG. 2D, whereby a duplicate program is completed (step S5). FIG. 2E shows the completed duplicate hologram, in which the master data pages are recorded in an N-multiplex state. Actually, such post-processes as irradiation of beam are sometimes required after the N-multiplexing, and a duplicate of the holograms is completed through the processes.

Here, when such an N-multiplex duplicate hologram is produced finally as described above, the value of N usually is equal to several tens to several hundreds, and in this instance, the hologram diffraction efficiency is very low. If the master disk itself is in an N-multiplexed form and it is tried to use contact copying for the master disk, then the intensity ratio between the signal beam 400 and the conical light beam 300 as a reference beam upon copying as seen in FIG. 4B becomes high, resulting in such a disadvantage that the diffraction efficiency of the duplicated holograms is very low or the intended multiplexity cannot be obtained. Therefore, multiplex recording is not applied to the master disk, and instead, N master disks D₁ to Dₙ are prepared as in the example described above. In this instance, it is possible to set the intensity ratio between the signal beam 400 and the conical light beam 300 upon copying to substantially 1:1 as seen in FIG. 4A, and good quality of a copy can be assured. Therefore, in the present embodiment, the N master disks D₁ to Dₙ are used to finally produce an N-multiplexed duplicate hologram.

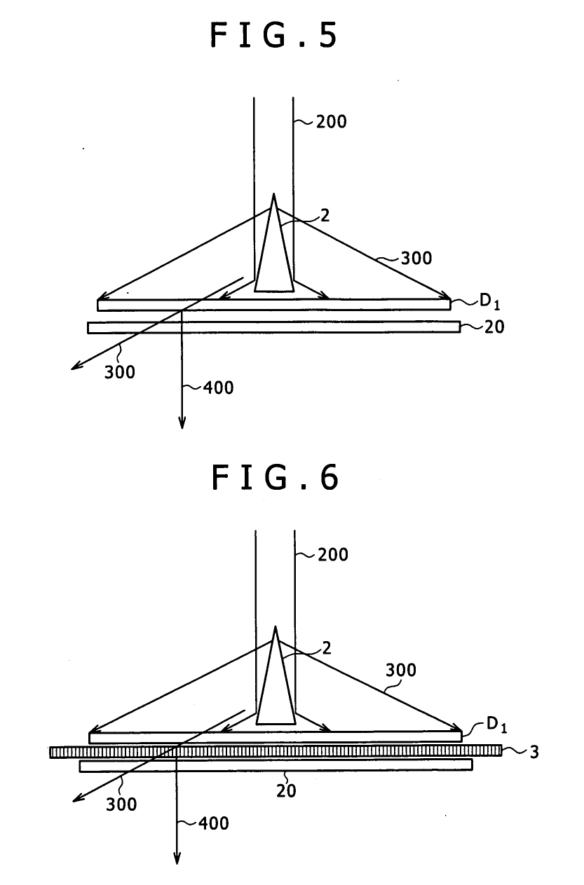

Further, in order to perform contact copying, it is necessary to collectively reproduce the master holograms recorded on the master disk. As described hereinabove, where the master disk produced in such a manner as described above is of the disk type, for the collective reproduction, a conical light beam is required, and in the example described above, the conical light beam 300 is produced using the conical beam producing optical part 1. However, another example wherein a cone (conical) mirror is used as the conical beam producing optical part 1 is shown in FIG. 5.

Referring to FIG. 5, a cone mirror 2 is disposed above the master disk D₁ in the form of a disk such that the center axis thereof coincides with the center of the master disk D₁, and a reference light beam 200 in the form of parallel beam is irradiated upon the cone mirror 2 from above. Consequently, the reference light beam 200 is reflected by an inclined face of the cone mirror 2 to form a conical light beam 300, which is irradiated upon the master disk D₁. The conical light beam 300 incoming to the master disk D₁ is diffracted by the hologram recorded on the master disk D₁ to make a signal beam 400, which is introduced into the duplication hologram material 20 disposed closely below the master disk D₁. At this time, the conical light beam 300 passing through the master disk D₁ as it is without being diffracted serves as reference light beam and interferes with the signal beam 400, and interference fringes by the conical light beam 300 and the signal beam 400 are recorded on the duplication hologram material 20. Consequently, the data page recorded as interference fringes on the master disk D₁ is copied collectively into the duplication hologram material 20.

Here, it is assumed that the diffraction efficiency of the master disk D₁ is in a state optimized for contact copying. Since usually the diffraction efficiency is high where the intensity ratio between reference light beam and signal beam is proximate to 1:1, preferably the diffraction efficiency of a master disk is set to approximately 50% where absorption and surface reflection are ignored. Further, though not particularly shown in order to avoid complicatedness, index matching liquid is sometimes filled between the master disk D₁ and the duplication hologram material 20. Further, while the cone mirror (conical mirror) 2 is used in FIG. 5 in order to produce a conical light beam, some other element such as a conical prism or a diffraction optical element may be used instead.

Further, in the example of FIG. 5, the adjustment of the intensity ratio between the signal beam 400 reproduced from the master disk D₁ and the conical light beam 300 passing through the master disk D₁ (that is, reference light beam upon contact copying) depends upon the diffraction efficiency of the master disk D₁. However, it is otherwise possible to dispose an optical part 3 having a high angle selectivity between the master disk D₁ and the duplication hologram material 20 as seen in FIG. 6 so that the intensity ratio of the signal beam 400 and the conical light beam 300 (in the example of FIG. 1, the conical light beam serves as reference light beam) can be adjusted.

It is assumed that the diffraction efficiency of the master disk D₁ is very low. In this instance, if the optical part 3 which has an optimized transmission factor so that it passes light beam well therethrough within an angular range within which the signal beam 400 is to pass but exhibits a reduced transmission factor for any other light beam having any other angle is disposed between the master disk D₁ and the duplication hologram material 20. Then a desired intensity ratio between the signal beam 400 and the conical light beam 300 as reference light is obtained. Such an optical part as described above may be a multilayer film coated mirror having a high angle dependency.

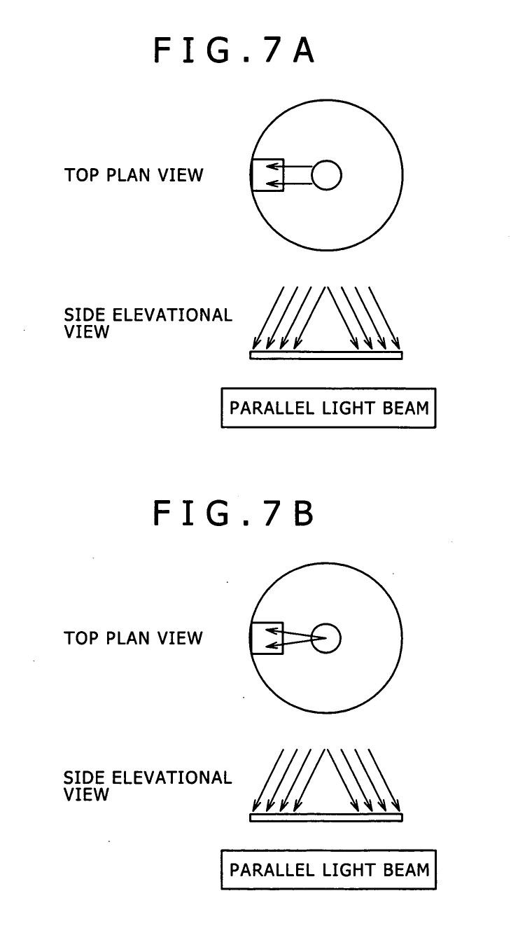

Further, in the description above, a parallel light beam similar to that used in ordinary angle multiplexing is used upon production of a master disk, and a conical light beam is used upon reproduction. Originally it is preferable to use the same wavefront for recording and reproduction, and although strictly a parallel light beam and a conical light beam are different from each other as seen in FIGS. 7A and 7B, since usually a hologram spot at one place is sufficiently small, the difference can be ignored. However, a parallel light beam cannot sometimes be approximated to a conical light beam. In this instance, a light beam having a same wavefront as that of a reference light beam used for duplication should be used upon master disk recording. In the example of FIG. 7A, where a conical light beam is used for reproduction, a conical light beam is used also for master disk recording. It is to be noted that such a conical light beam as seen in FIG. 7B can be produced readily using a cylindrical lens.

Here, holograms can be classified into a thick hologram and a thin hologram using a parameter called Q value described below. Where λ represents the wavelength, T the thickness of the recording layer and d the length of one cycle of interference fringes, the Q value can be represented by Q=2πλ/nd . Where Q<1, the hologram is called thin hologram, and where Q>10, the hologram is called thick hologram. For example, where 632.8 nm of a HeNe laser is used as the recording wavelength and holograms wherein the length of one cycle of interference fringes is 1 μm is to be recorded, the necessary thickness of the recording layer is approximately 0.25 μm for thin holograms and 2.5 μm or more for thick holograms.

From a thick hologram, an image is reproduced only when the Bragg condition is satisfied. In particular, a thick hologram has a high angle selectivity and a high wavelength selectivity while a thin hologram has a low angle selectivity and a low wavelength selectivity. In the embodiment described above, since none of the master holograms recorded on the master disks D₁ to Dₙ is in a multiplex recoded state, it need not have an angle selectivity, but an angle selectivity is required only for the side on which the hologram is duplicated, that is, only for a hologram recorded on the duplication hologram material 20. Where a master hologram has an angle selectivity, a very severe angular tolerance is required for reproduction illumination light beam used for contact copying. However, where a thin hologram is used for the master holograms, the angle selectivity can be lowered to moderate the angle tolerance.

According to the embodiment described above, by performing copying to one duplication hologram material 20 of the disk type by a plural number of times from a plurality of disk type master disks D₁ to Dₙ using a conical light beam, data pages recorded in accordance with the angle multiplex method on disk type recording media can be duplicated readily. Further, a large number of disks of the ROM type wherein the same information is recorded can be produced. Consequently, the range of application of hologram recording can be widened significantly.

Further, where angle multiplex recording is applied, the time required to copy one record to the duplication hologram material 20 is shorter than 1 second by collectively exposing the recorded hologram of, for example, the master disk D₁ using the conical light beam 300. However, since this operation must be repeated N times in order to complete copying of the N-multiplex records, according to a simple calculation, N seconds or more are required for the completion. Actually, however, by applying batch processing, the tact time per one copy becomes a value almost on the order of one second, and consequently, a large number of copy disks can be produced in a short period of time.

Further, where a thin hologram is used for the master holograms, the angle selectivity can be lowered to moderate the angle tolerance.

### Second Embodiment

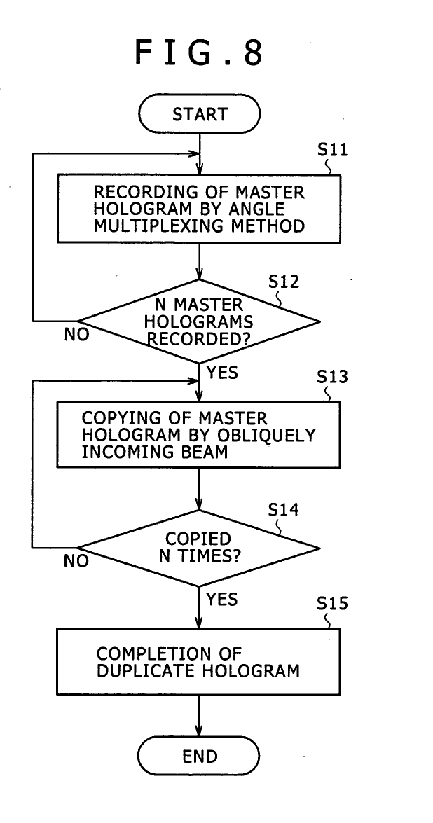

FIG. 8 illustrates a general procedure of another hologram duplication method to which the present invention is applied and particularly illustrates a method of duplicating a hologram recording medium of the card type.

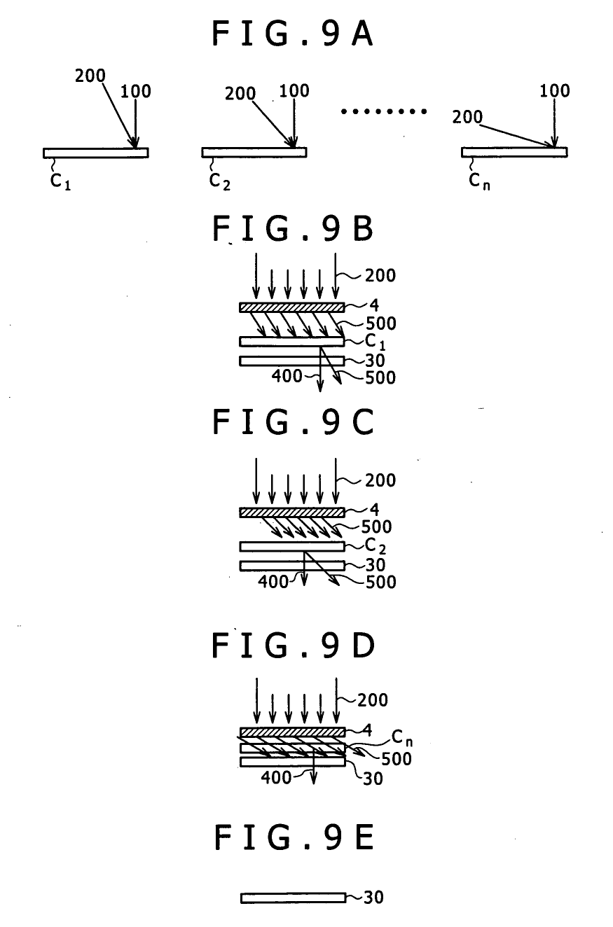

Referring to FIG. 8, N master disks of the angle multiplex type are produced (steps S11 and S12). In particular, as seen in FIG. 9A, data pages to be N-multiplexed originally are recorded, on a duplication hologram material 30 in the form of a card for each one data page, as interference fringes between a reference light beam 200 whose incoming angle varies and a signal light beam 100 spatially optically modulated by the data page. Consequently, N master cards C₁ to Cₙ are produced.

Then, copying of recorded data of the N master cards C₁ to Cₙ to one duplication hologram material 30 is performed (steps S13 and S14). More particularly, the reference light beam 200 in the form of parallel light beam is converted into an obliquely incoming beam 500 by means of an obliquely incoming beam producing optical part 4 as seen in FIG. 9B, and the obliquely incoming beam 500 is irradiated upon the master card C₁. In this instance, the incoming angle of the obliquely incoming beam 500 to the master card C₁ is set equal to the incoming angle of the reference light beam 200 used for production of the master card C₁. Consequently, signal beam 400 is reproduced in accordance with the hologram data recorded on the master card C₁, and the signal beam 400 and the obliquely incoming beam 500, which has passed through the master card C₁ without being diffracted by the master card C₁, interfere with each other on the duplication hologram material 30. Thereupon, interference fringes of the signal beam 400 and the obliquely incoming beam 500 are recorded in the duplication hologram material 30. The data page recorded in the master card C₁ is copied collectively to the duplication hologram material 30.

Then, the data page recorded in the master card C₂ is copied to the same duplication hologram material 30 by a similar method as seen in FIG. 9C. In this instance, however, the incoming angle of the obliquely incoming beam 500 to the master card C₂ is set equal to the incoming angle of the reference light beam 200 used for production of the master card C₂. Therefore, the obliquely incoming beam producing optical part 4 to be used in this instance is exchanged for another obliquely incoming beam producing optical part ready for the incoming angle. At this point of time, data pages are recorded in a two-multiplexed form on the duplication hologram material 30. Thereafter, a similar process is repeated until a data page recorded on the master card Cₙ is copied to the same duplication hologram material 30 as seen in FIG. 9D, whereby a duplicate program is completed (step S15). FIG. 9E shows the completed duplicate hologram, in which the original data pages are recorded in an N-multiplexed state. Actually, such post-processes as irradiation of light beam are sometimes required after the N-multiplexing, and a duplicate of the holograms is completed through the processes.

According to the present embodiment, by copying to a single duplication hologram material 30 by a plural number of times from a plurality of master cards C₁ to Cₙ using the obliquely incoming beam 500, data pages recorded on the card type recording medium in accordance with the angle multiplex method can be duplicated readily. Thus, similar advantages to those of the first embodiment are achieved.

While preferred embodiments of the present invention have been described using specific terms, the present invention is not limited to the embodiments described above but can be carried out in various modified forms in terms of the particular configuration, function, action and effect. For example, while, in the embodiments described above, N (natural number) master disks on each of which a data page is recorded without being multiplexed are used to copy N-multiplex holograms to a single duplication hologram material, if no or little deterioration of the diffraction efficiency is involved, N/M master disks on each of which M (natural number) data pages are recorded in a multiplexed form may be used to copy to a single duplication hologram material. In this instance, if N/M has a fraction, then the fraction is raised to unit, and the last one master disk has less than M data pages recorded in a multiplexed form. Or, the multiplexities of the master disks are not set equal to each other but adjusted suitably. For example, five multiplex data pages are copied into the same duplication disk using a master disk have two of the five multiplex data pages recorded thereon and another master disk having the other three of the five multiplex data pages recorded thereon thereby to record the five multiplex data pages in the duplication disk. By the countermeasure described above, the number of times of copying can be reduced approximately to N/M, and the time required for production of a duplicate disk on which data pages are N-multiplex recorded can be reduced. Further, if the diffraction efficiency does not suffer from deterioration, it is possible to use a single master disk on which data pages are N-multiplex recorded and copy the data pages once to a single duplication hologram material thereby to produce an N-multiplex duplicate disk.

Further, while the foregoing description of the embodiments is given taking a transmission type hologram as an example, a similar method can be applied to duplicate a reflection type hologram as well.

What is claimed is:

1. A hologram duplication method for duplicating data pages recorded in a holographic form on a disk type master recording medium on a disk type duplication recording medium disposed in the proximity of the disk type master recording medium, the method comprising the steps of:
irradiating a conical light beam upon the disk type master recording medium, and
recording interference fringes collectively on the disk type duplication recording medium, wherein the interference fringes are formed with signal beam produced by diffraction of the conical light beam by the disk type master recording medium and the conical light beam passing through the disk type master recording medium.

2. The hologram duplication method according to claim 1, wherein N disk type master recording media are prepared, N being a natural number, and the data pages are individually recorded on the N disk type master recording media without being multiplexed by changing the angle of a reference light beam among the N disk type master recording media, whereafter the data page recorded on each of the disk type master recording media is recorded on the common disk type duplication recording medium so that the data pages are N-multiplex recorded finally on the disk type duplication recording medium.

3. The hologram duplication method according to claim 2, wherein the master hologram recorded on each of the disk type master recording media is a thin hologram.

4. The hologram duplication method according to claim 1, wherein M disk type master recording media are prepared, M being a natural number, and the data pages are individually recorded on the M disk type master recording media in a two- or more-multiplex state in accordance with an angle multiplex method, whereafter the data pages recorded on each of the disk type master recording media are recorded on the common disk type duplication recording medium in a two- or more-multiplex state by changing the angle of the reference light beam among the M disk type master recording media so that the data pages are N-multiplex recorded finally on the disk type duplication recording medium, N being greater than M.

5. The hologram duplication method according to claim 1, wherein a single disk type master recording medium is prepared, and the data pages are N-multiplex recorded on the disk type master recording medium in accordance with an angle multiplex method, N being a natural number, whereafter the data pages N-multiplex recorded on the disk type master recording medium are N-multiplex recorded on the disk type duplication recording medium by changing the incoming angle of the conical light beam.

6. The hologram duplication method according to claim 1, wherein the conical light beam is produced by passing a parallel light beam through a cylindrical lens or a diffraction optical element or irradiating a parallel light beam upon a conical mirror.

7. The hologram duplication method according to claim 1, wherein a reference light beam irradiated in order to record a data page on the disk type master recording medium is not a parallel light beam but a conical light beam similar to that used upon duplication.

8. The hologram duplication method according to claim 1, wherein an optical part having a high angle dependency is interposed between the disk type master recording medium and the disk type duplication recording medium.

9. The hologram duplication method according to claim 1, wherein the incoming angle of a reference light beam irradiated in order to record a data page on the disk type master recording medium is varied within a plane defined by a disk normal line and a disk radial direction.

10. A hologram duplication method for duplicating data pages recorded in a holographic form on a card type master recording medium on a card type duplication recording medium disposed in the proximity of the card type master recording medium, the method comprising the steps of:
irradiating a obliquely incoming light beam upon the card type master recording medium, and
recording interference fringes collectively on the card type duplication recording medium, wherein the interference fringes are formed with signal beam produced by diffraction of the obliquely incoming light beam by the card type master recording medium and the obliquely incoming light beam passing through the card type master recording medium.

11. The hologram duplication method according to claim 10, wherein N card type master recording media are prepared, N being a natural number, and the data pages are individually recorded on the N card type master recording media without being multiplexed by changing the angle of a reference light beam among the N card type master recording media, whereafter the data page recorded on each of the card type master recording media is recorded on the common card type duplication recording medium so that the data pages are N-multiplex recorded finally on the card type duplication recording medium.

12. The hologram duplication method according to claim 10, wherein M card type master recording media are prepared, M being a natural number, and the data pages are individually recorded on the M card type master recording media in a two- or more-multiplex state in accordance with an angle multiplex method, whereafter the data pages recorded on each of the card type master recording media are recorded on the common card type duplication recording medium in a two- or more-multiplex state by changing the angle of the reference light beam among the M card type master recording media so that the data pages are N-multiplex recorded finally on the card type duplication recording medium, N being greater than M.

13. The hologram duplication method according to claim 10, wherein a single card type master recording medium is prepared, and the data pages are N-multiplex recorded on the card type master recording medium in accordance with an angle multiplex method, N being a natural number, whereafter the data pages N-multiplex recorded on the card type master recording medium are N-multiplex recorded on the card type duplication recording medium by changing the incoming angle of the obliquely incoming light beam.

14. The hologram duplication method according to claim 10, wherein an optical part having a high angle dependency is interposed between the card type master recording medium and the card type duplication recording medium.
